(19) United States
(12) Patent Application Publication
(10) Pub. No.: US 2012/0061970 A1
(43) Pub. Date: Mar. 15, 2012

(54) Shrouded Wind Turbine with Integral Generator

(76) Inventor: Borislav Zivkovich, Hammond, IN (US)

(21) Appl. No.: 13/099,138

(22) Filed: May 2, 2011

Related U.S. Application Data
(63) Continuation of application No. 12/881,850, filed on Sep. 14, 2010, now abandoned.

(51) Int. Cl. F03D 9/00; F03D 11/00; F03D 1/00

(52) U.S. Cl. 290/55; 416/42; 416/169 R

(57) ABSTRACT

The invention provides a system for capturing moving air and extracting energy from the moving air, the system comprising. A rotor cone is provided having an outer surface, the rotor cone being rotatable about its central axis and having a plurality of veins affixed upon the outer surface of the rotor cone, for receiving a force from the moving air in order to rotate the rotor cone. A shroud surrounds the rotor cone and extends past the narrow end of the cone, opening to an open end having a diameter substantially equal to that of the cone. When moving air enters the shroud at the open end, the moving air compresses within the shroud until it reaches the cone, passes between the cone and the shroud, and impacts the plurality of veins, rotating the cone. A generator within the cone generates electrical energy. In an embodiment, a system is provided for opening the gap between the cone and the shroud under heavy wind to bypass a portion of the moving air. In a further embodiment, a weight redistribution system is provided to increase the rotational inertia of the cone as a function of the rotational speed of the cone.

### CROSS-REFERENCE TO RELATED APPLICATIONS

This application is a continuation of U.S. application Ser. No. 12/881,850, filed Sep. 14, 2010, which is hereby incorporated by reference in its entirety.

### BACKGROUND OF THE INVENTION

As fossil fuels and other non-renewable energy sources become more costly to obtain, and as the environmental impact of the use of such fuels becomes fully known, there has been a resurgence in the popularity of renewable energy sources such as wind, solar, tidal, and other energy technologies. Of these, wind energy is not only the most ancient, but perhaps the most promising as well, due to its simplicity.

However, the efficiency of wind energy capture devices is still far less than complete. Indeed, a typical wind turbine has blades that capture only about three percent of the passing air. Coupled with the low efficiency in converting the rotating blade movement to electrical energy, this means that existing wind turbines must be quite large and quite numerous to supply a meaningful amount of energy.

In addition to being energetically inefficient, present day rotor designs also require expensive engineering and materials to generate and maintain. For example, a typical wind turbine rotor blade is in excess of 40 meters long. Such rotor blades experience significant additional structural loading in operation due to the magnitude and weight of the structure itself. Furthermore, traditional large rotor blades rotate through a very large vertical plane, leading to significant cyclic loading. This speeds the deterioration of the structure and the need for costly maintenance or replacement.

Thus, the inventor desires to improve the structural and energetic efficiency of wind energy capture devices as described hereinafter. rotor cone being rotatable about its central axis and having a plurality of veins affixed upon the outer surface of the rotor cone, for receiving a force from the moving air in order to rotate the rotor cone. A shroud surrounds the rotor cone and extends past the narrow end of the cone, opening to an open end having a diameter substantially equal to that of the cone. When moving air enters the shroud at the open end, the moving air compresses within the shroud until it reaches the cone, passes between the cone and the shroud, and impacts the plurality of veins, rotating the cone. A generator within the cone generates electrical energy. In an embodiment, a system is provided for opening the gap between the cone and the shroud under heavy wind to bypass a portion of the moving air. In a further embodiment, a weight redistribution system is provided to increase the rotational inertia of the cone as a function of the rotational speed of the cone.

### BRIEF DESCRIPTION OF THE SEVERAL VIEWS OF THE DRAWING(S)

FIG. 1 is a simplified cross-sectional side view of a rotor cone and shroud in accordance with an embodiment of the invention;

FIG. 2 is a perspective side view of a wind turbine system cone in accordance with an embodiment of the invention;

FIG. 3 is a perspective top view of a wind turbine system cone in accordance with an embodiment of the invention;

FIG. 4 is a cross-sectional view of a rotor cone in accordance with an embodiment of the invention; and

FIG. 5 is a simplified schematic side view of the wind turbine system according to an embodiment of the invention including a weight redistribution system for automatically increasing the rotational moment of the wind turbine cone to increase the rotational energy of the system.

### DETAILED DESCRIPTION OF THE INVENTION

Prior to discussing the minute details of the invention, a brief overview will be given to orient the reader. As noted above, traditional wind turbine rotor blades are energetically inefficient for at least the reason that they capture a very small fraction of the air traversing the rotor disc. Despite this small coverage, such blades are extremely long, with the end result that such turbines are not only inefficient but also structurally compromised.

The present invention eliminates both sources of loss and expense by providing a rotor disc having 360 degrees of coverage in the disc plane, and having a low rotor disc radius compared to traditional rotors. The end result is a higher capture and conversion efficiency in a structure that is mechanically far stronger than existing turbine structures. Moreover, the device described herein requires less airspace to operate, vertically and laterally, and hence allows for more efficient land usage.

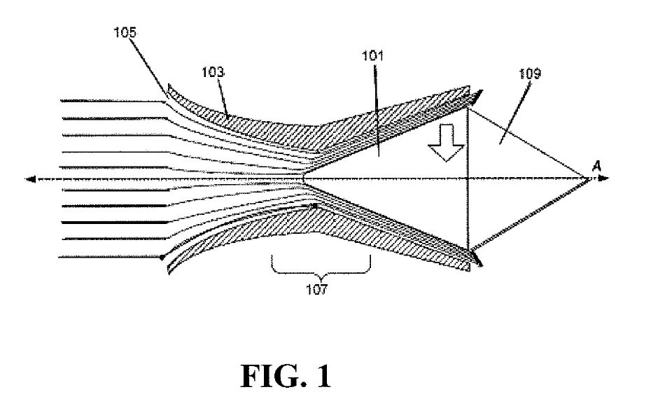

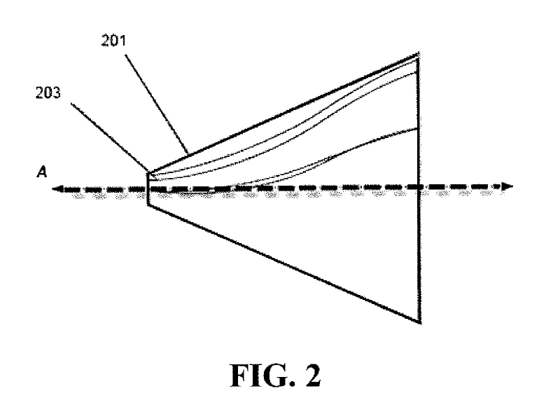

Turning to the figures, FIG. 1 is a simplified cross-sectional side view of a rotor cone and shroud in accordance with an embodiment of the invention. The rotor blades have been omitted for clarity, but will be discussed in greater detail later with respect to FIG. 2. At any rate, referring to FIG. 1, the turbine system 100 includes an inner cone 101 and an outer shroud 103. It will be appreciated that the figure is simplified and that numerous components and structures are omitted for clarity. The shroud 103 may be a multi-layer insulated structure so as to prevent ambient solar heat from affecting the turbine.

The inner cone 101 rotates about its central axis A, in a direction dependent upon its blade structure (not shown here). The outer shroud 103 collects incoming air at circular opening 105 and directs the collected air, under force of its inertia as well as subsequent incoming air, into a lower volume higher pressure area 107. After passing through the lower volume higher pressure area 107, the kinetic energy of the entrained air is extracted via spinning of the cone 101 as the air passes between the shroud 103 and the cone 101 and impacts the blades of the cone.

It will be appreciated from the figure that although the distance between the shroud 103 and the cone 101 changes little, the three-dimensional volume of the entrained air increase as the air progresses along the cone due to the increased circumference and hence increased unit volume. Moreover, it will be appreciated that although the air flow is shown as lying continuously in a single axial plane, the actual airflow will rotate as it interacts with the cone 101. In this way, the entrained air will be subject to a centripetal force that further influences it to continue along the cone as further energy is extracted, resulting in a very efficiency of energy extraction.

Moreover, it can be appreciated from the figure that the surface of incoming air is entirely captured. This is in contrast to a traditional bladed system wherein the capture efficiency is limited by the fact the blade areas, taken together, still only account for a small percentage of the total rotor disc area.

Once the entrained air has passed the extent of the cone 101 it may flow in a laminar manner against an exit cone 109. This prevents or minimizes turbulent flow at the exit of the shroud, thus improving efficiency.

Before discussing the manner in which the rotational energy of the cone 101 is converted to electrical energy, the details of the cone 101 will addressed in somewhat greater detail in accordance with an embodiment of the invention by way of FIG. 2. Referring now to FIG. 2, a perspective side view of a wind turbine system cone in accordance with an embodiment of the invention is shown. As can be seen in the perspective side view of the rotor cone 201 in accordance with an embodiment of the invention, the rotor cone 201 includes a plurality of generally axially extending and circumferentially wrapping veins or blades 203. The blades 203 also extend in the radial dimension from the surface of the cone 201. While the radial extent of the blades 203 is not critical, the extent should be such that the blades extend almost to the shroud (not shown) without coming into contact with the shroud. Thus, in an embodiment of the invention, the radial extent of the blades 203 is 8 inches, leaving a gap of approximately one eighth of the entire tunnel's size.

As noted above, the surface speed of the cone increases as the circumference of the cone increases. Thus, in order to minimize the spin imparted to the air stream, the blades are shaped in accordance with the changing circumference and surface speed of the spinning cone 201, and are thus increasingly inclined in proportion to the increasing circumference. In an exit region 205, the blade shape momentarily reverts to a less inclined configuration before terminating. This is done so that any rotational effect of the device on the air mass may be eliminated or at least partially mitigated as the air exits the device.

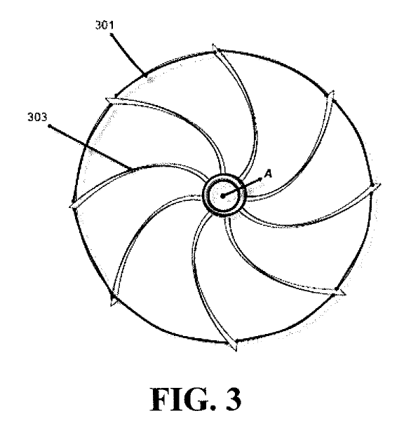

For ease of understanding the cone 101/201 is shown in front view in FIG. 3. As can be seen, the cone 301 includes blades 303 attached to the surface of the cone 301 and extending slightly from the cone 301. The blades are in affixed position and curved in a manner to maximize the receipt of air flow pressure for transmission into rotational energy (not shown in FIG. 3).

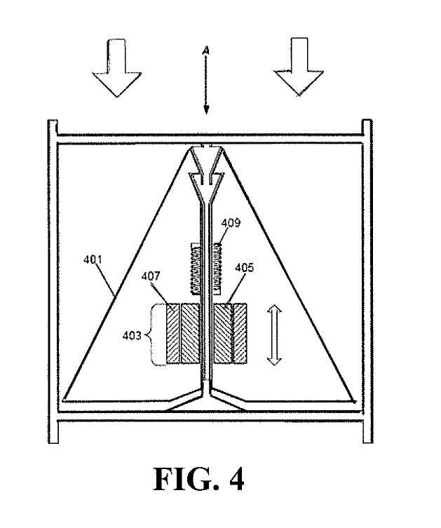

The above discussion clarifies the manner in which wind energy is efficiently converted to mechanical energy in embodiments of the invention. While mechanical energy may be directly used, it is more desirable in an embodiment of the invention to convert the extracted energy to a form that may be easily transported, stored, and used, i.e., electrical energy. To this end, FIG. 4 is a cross-sectional view of a rotor cone 401 in accordance with an embodiment of the invention, showing an electrical energy generation mechanism within the cone 401. The figure also discloses a wind compensation mechanism that will be discussed at a later point.

The electrical energy generation mechanism in the illustrated example includes a generator 403 that is powered by the rotation of the cone 401 under the influence of the blades (not shown in this figure). The generator may operate as an AC or DC generator depending upon builder preference. The generator 403 comprises and outer portion 405 and an inner portion 407. It is the relative movement of the inner and outer portions 405, 407 that is used to generate electrical energy. To this end, one portion, in this case the outer portion 407, includes a plurality of magnets, while the other portion in this case the inner portion 405, includes a plurality of electrical conductor coils about cores, as will be appreciated by those of skill in the art.

Because it is the relative motions of the portions that creates electrical energy, in an embodiment of the invention, the outer portion 407 moves with the cone 401, while the inner portion is geared to the outer portion 407 as to rotate in an opposite direction, thus increasing the relative speed of passage. The mechanism for this gearing is not critical, however, in an embodiment of the invention, a planetary arrangement is used. Those of skill in the art will appreciate that numerous other arrangements may be used instead without departing from the scope of the invention.

A brushed system may be used to convey the electrical energy generated in this manner to a stationary, i.e., nonrotating point, such as the frame of the system. Depending upon power requirements and capabilities, two or four brushes, or some other number, may be used. In an embodiment, magnets may be placed on the cone for additional electrical power generation, and an additional set of brushes used to convey the generated power from the rotating cone to a stationary conduit.

In an embodiment of the invention, the number of brushes engaged is variable, to accommodate changing wind conditions. In particular, in the illustrated system, the cone 401 is configured to be pushed back against spring 409 in the presence of strong winds, in order to preserve the structure. As the cone 401 is pushed rearward under heavy wind, the distance between the cone 401 and the shroud (not shown) increases, allowing a greater volume of air to bypass the cone 401 and associated blades. Thus, the system is self-correcting to avoid excess strain.

Further, as the cone 401 moves rearward, sliding contacts change the number of brushes engaged to extract a greater amount of electrical energy from the spinning cone 401. In an embodiment of the invention, once the cone has moved completely to the end of the structure where it cannot accept more wind due to maximum internal cone wind pressure, the cone will activate a mechanism, in a spring loaded fashion, that will disengage the isometric designed unit from its current wind-directional fixed position on its tower. This will allow the unit to turn from front-to-back, reversing itself, and preserving the unit from component damage. While it is in its reversed position, the existing wind pressure will add constant pressure to the safety cone, which will keep the motor disengaged until the internal wind pressure normalizes. However, when the wind subsides enough, it will release a pin in the yaw system's motor allowing the motor to engage the gears and move the unit toward a current angle based on the received wind direction information.

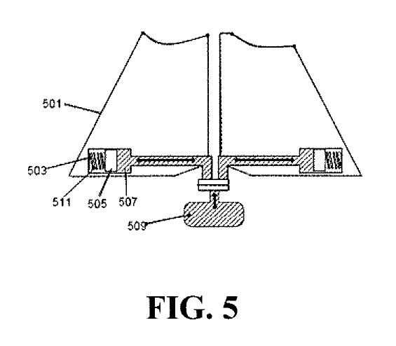

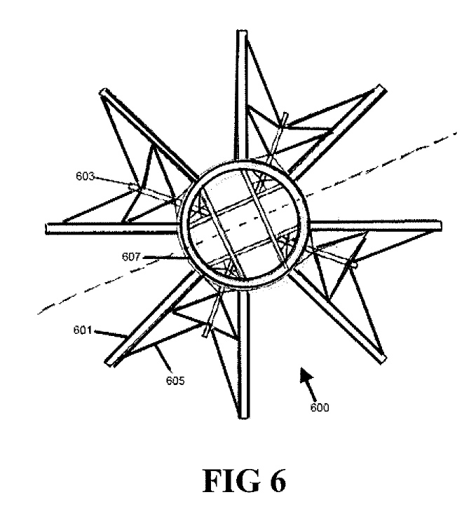

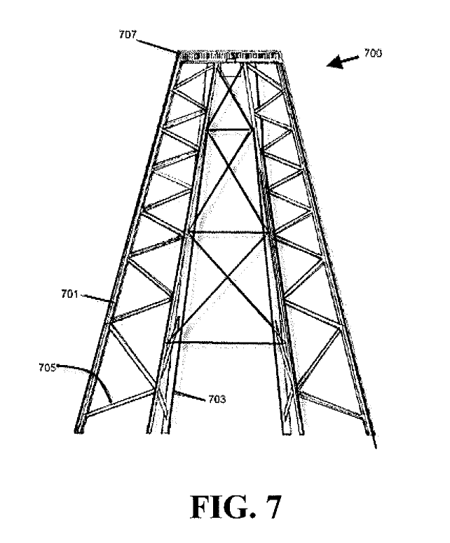

Because it is the rotational energy of the cone 401 that is converted to energy, an increase in the rotational energy available at a given rotation speed will also allow greater energy to be stored in and retrieved from the cone 401. In this regard, FIG. 5 shows a weight redistribution system for automatically increasing the rotational moment of the wind turbine cone to increase the rotational energy of the system. The system may be mechanically or electrically automated, and the illustrated system is of the former variety.

In this embodiment, the rear of the cone 501 includes a plurality of tubular chambers 503 which rotate with the cone 501. Although two such chambers 503 are shown due to the cross-sectional nature of the drawing, a greater number of chambers 503 may be used as desired. In any case however, the chambers 503 should be balanced in size and position so as not to create an off-center axis of rotation.

Each chamber 503 includes a sealed piston 505, and a body of oil, hydraulic fluid or other weighting fluid 507. The oil in the chambers 503 may be drawn from one or more reservoirs 509 via a rotary union or the like. Although not shown, the top of each chamber may be vented to allow free movement of the piston 505. A spring 511, placed as shown at the top of the chamber 503 or placed elsewhere in the system and connected directly or hydraulically to the piston 505, allows the radial position of the piston 505 to increase with increasing cone speed, thus enhancing the rotating weight of the cone 521.

As noted above, the turbine assembly shown in the preceding figures is mounted on a framework pedestal, which includes elements for support, rotation, e.g., to match wind direction, and for conveying electrical power generated by the system. In an embodiment of the invention, the support includes or is connected to a wind sensor and a motor, such that the motor rotates the turbine to face most directly into the wind. In this embodiment, if the wind pressure on the turbine exceeds a threshold level indicating that it is reaching a damaging level, the motor will activate to pivot the turbine away from the wind until the wind decreases again to a safe level.

The structure of the base portion is not critical in every embodiment, but an exemplary structure is shown in FIG. 6. This FIG. represents a top elevation view of the base tower 600, showing various supports. In the illustrated example, the tower 600 includes eight external supports 601 and 4 internal supports 603, with the internal supports 603 being at a steeper angle so as to have ground contact points inside the contact points for the external supports 601. The external supports 601 are braced in pairs, e.g., by cables 605, to the internal supports 603, so as to provide rigidity in all horizontal directions to resist wind loads as well as in the vertical direction to support the weight of the turbine system.

A platform 607 is located at the top of the tower 600 for supporting the wind turbine system. A system of bearings, not shown, may be included in the platform 607 to support the turbine system and to allow rotation of the turbine about the vertical axis. The tower 600 is shown in side elevation view in FIG. 7 as tower 700. In this FIG., like numerals refer to like elements in regard to those of FIG. 6. Thus, the external supports 601, internal supports 603, cables 605, and platform 607 are shown as elements 701-707 respectively in FIG. 7.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A system for capturing moving air and extracting energy from the moving air, the system comprising:
a rotor cone having an outer surface, the rotor cone being rotatable about its central axis;
a plurality of veins affixed upon the outer surface of the rotor cone, for receiving a force from the moving air so as to rotate the rotor cone;
a shroud surrounding the rotor cone such that the shroud has an essentially conical inner surface adjacent the cone and extends past the narrow end of the cone, opening as it extends to an open end having a diameter substantially equal to that of the cone; and
a generator affixed centrally within the cone and having an outer portion adapted to move with the movement of the cone, such that when the moving air enters the shroud at the open end, the moving air compresses within the shroud until it reaches the cone, passes between the cone and the shroud, and impacts the plurality of veins, forcing the cone to rotate, and thereby generating electrical energy at the at least one generator.

2. The system for capturing moving air and extracting energy from the moving air according to claim 1, further comprising a central shaft, upon which the cone is axially movable, and a spring biasing the cone toward the open end of the shroud, such that under heavy wind, the cone is adapted to move rearward, opening the gap between the cone and the shroud, allowing bypass of a portion of the moving air.

3. The system for capturing moving air and extracting energy from the moving air according to claim 1, further comprising a weight redistribution system to increase the rotational inertia of the cone as a function of the rotational speed of the cone.

4. The system for capturing moving air and extracting energy from the moving air according to claim 3, wherein the weight redistribution system comprises a plurality of fluid chambers capped by pistons, the fluid chambers being situated at the periphery of the cone and being linked fluidly to a central source of fluid, whereby movement of the pistons draws fluid from the central source of fluid toward the periphery of the cone.

5. The system for capturing moving air and extracting energy from the moving air according to claim 4, wherein, as movement of the pistons draws fluid from the central source of fluid toward the periphery of the cone and the axial moment of the cone changes as a result of increased pressure and R.P.M.s, the generator poles will adjust between four and two poles.

6. A wind-powered electrical generator system having a central rotating element, multiple blades fixed to the central rotating element, and an element for slowing the rotation of the blades and hence the central rotating element in order to absorb further wind power.

7. A wind-powered electrical generator system having a central rotating element, multiple blades fixed to the central rotating element, a carrier for supporting the central rotating element and aiming the multiple blades so as to optimize wind capture, the system further comprising a damage prevention subsystem operable to redirect the multiple blades and the central rotating element to lessen wind power capture while the wind pressure remains above a threshold value.

8. The system for capturing moving air and extracting energy from the moving air according to claim 1, further comprising a support tower comprising a first set of legs forming a first contact circle on the ground, a second set of legs forming a second contact circle on the ground, the second circle being within the first circle, the first set of legs being twice in number compared to the second set of legs, and each of the second set of legs being braced to a pair of the first set of legs.
